(19) United States
(12) Patent Application Publication
(10) Pub. No.: US 2004/0108398 A1
(43) Pub. Date: Jun. 10, 2004

(54) Drum shredder

(75) Inventor: Charles Lepage, Saskatoon (CA)

Correspondence Address: Attention: David R. Price, MICHAEL BEST & FRIEDRICH LLP, 100 East Wisconsin Avenue, Milwaukee, WI, 53202-4108, US

(73) Assignee: Highline Mfg. Inc., Vonda (CA)

(21) Appl. No.: 10/309,922

(22) Filed: Dec. 4, 2002

(51) Int. Cl. B02C 18/22

(52) U.S. Cl. 241/55; 241/56; 241/92

(57) ABSTRACT

A drum shredder including a fan aggression adjustment system provides easy-to-use control for the speed of processing bales and the cut length of the material removed from the bale as a result of the processing. Additionally, a loading frame, which preferably has forks and includes a conveyance system, assists in the loading of bales into the processing tub without the use of external loading machinery.

### FIELD OF THE INVENTION

The present invention relates to farm machinery for shredding bales and, more particularly, to a drum shredder.

### BACKGROUND

In the livestock industry, large round and square bales are shredded to feed and bed livestock. The most common type of bale processors currently in the market typically include a flail drum which is mounted longitudinally inside a processing chamber. This flail drum engages a bale of material inside the processing chamber, shreds the material and distributes the shredded material to one side of the bale processor. Exemplary bale processors of this type are those currently sold by the Applicant. Problems with this type of bale processor include difficulty controlling processing speed and consistency, and difficulty controlling the cut length of the shredded material.

The “drum shredder” is another type of bale processor in which a bale is loaded into a processing tub that tilts and rotates to bring the bale in contact with a cutting device (typically, a cutting fan) that processes the baled material. An exemplary drum shredder is disclosed in U.S. Pat. No. 4,934,615 owned by Teagle Machinery Ltd. of Cornwall, U.K..

Although existing drum shredders and tub grinders allow the user to control feed rate and cut length, exercising this control is difficult. Additionally, the loading of large round and square bales into these bale processors is generally performed by separate machinery.

The present invention is intended to provide an improved drum shredder, including provision for easy adjustment of processing speed and cut length, that processes baled material consistently and provides convenient means for loading bales.

### SUMMARY

A drum shredder is disclosed including an aggression adjustment system for the cutting device, which provides an easy-to-use control for the processing speed and cut length. A loading frame that assists in loading bales into the processing tub without the use of external loading machinery is also disclosed.

In accordance with an aspect of the present invention there is provided a drum shredder comprising a processing tub having a longitudinal axis, a closed end and an open end, said open end being adapted to receive a bale to be shredded in said processing tub; and a cutter operable to cut material from said bale for discharge from said drum shredder mounted toward said closed end of said processing tub such that the extent of protrusion of said cutter into said processing tub may be adjusted, along an axis generally parallel to said longitudinal axis of said processing tub, to vary the length of the material cut.

In accordance with another aspect of the present invention there is provided a drum shredder comprising a processing tub having a longitudinal axis, a closed end and an open end, said open end being adapted to receive a bale to be shredded in said processing tub wherein said processing tub is mounted on a tub frame and wherein a loading frame is pivotally mounted to said tub frame and adapted to pivot between a loading position wherein said bale to be shredded is loaded on said loading frame and a tub acceptance position wherein said loading frame is pivoted toward said open end of said processing tub to facilitate loading of said bale to be shredded into said processing tub.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate an embodiment exemplary of the invention:

FIG. 1 is a perspective view of a drum shredder according to the invention;

FIG. 2 is a perspective view of the back and left side of the drum shredder of FIG. 1;

FIG. 3 is a top view of the drum shredder of FIG. 1;

FIG. 4 is a sectional view of the drum shredder of FIG. 1 along sections line A-A shown in FIG. 3;

FIG. 5 is a side elevation view of the drum shredder of FIG. 1 showing the pivoting of the tub frame and the loading frame;

FIG. 6 is a perspective view of the front of an exemplary fan for use in the drum shredder of FIG. 1;

FIG. 7 is a perspective view of the back of the exemplary fan of FIG. 6;

FIG. 8A is a top view of a front wall of a processing tub of the drum shredder of FIG. 1 showing a fan aggression adjustment system, where the fan aggression adjustment system is in a first state;

FIG. 8B is a view of FIG. 8A where the fan aggression adjustment system is in a second state; and

FIG. 9 is a perspective view of the front and left side of the drum shredder of FIG. 1 wherein an axle assembly has been exploded to show a width adjustment mechanism.

### DETAILED DESCRIPTION

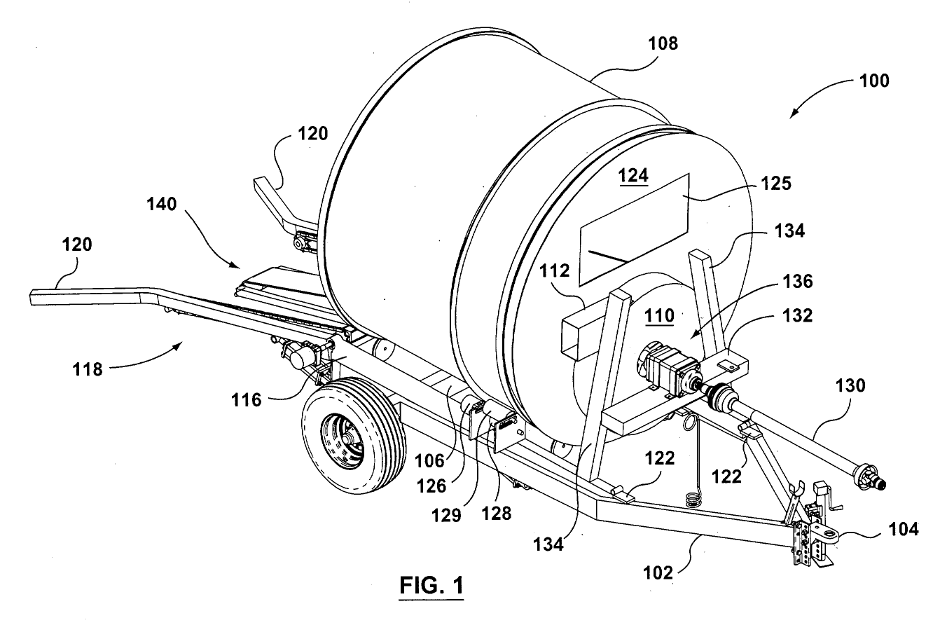

FIG. 1 illustrates a drum shredder 100 according to an embodiment of the present invention.

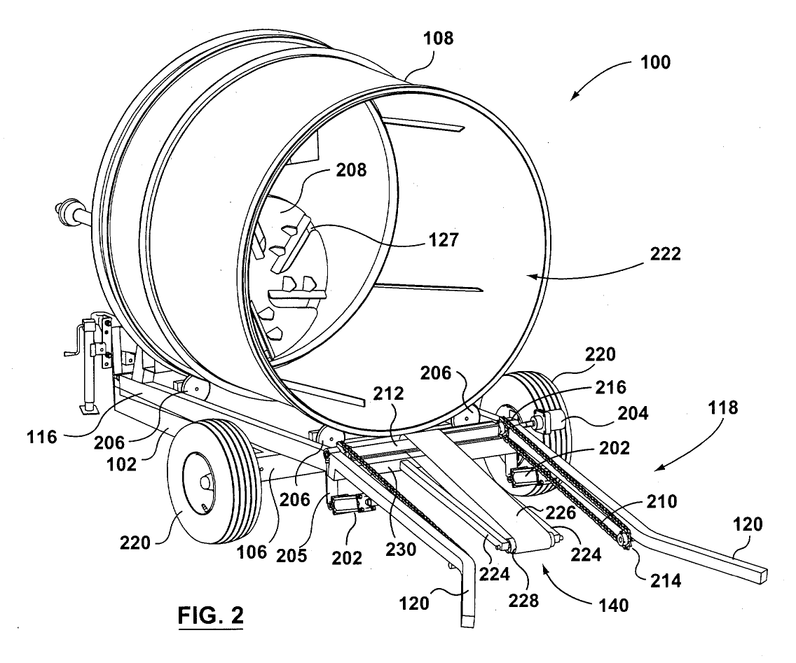

The drum shredder 100 has a frame structure that includes a main frame 102 having a hitch 104 and an axle assembly 106. The hitch 104 on the main frame 102 allows for connection of the drum shredder 100 to a tractor. The axle assembly 106 supports the main frame 102 on two wheels 220 (see FIG. 2).

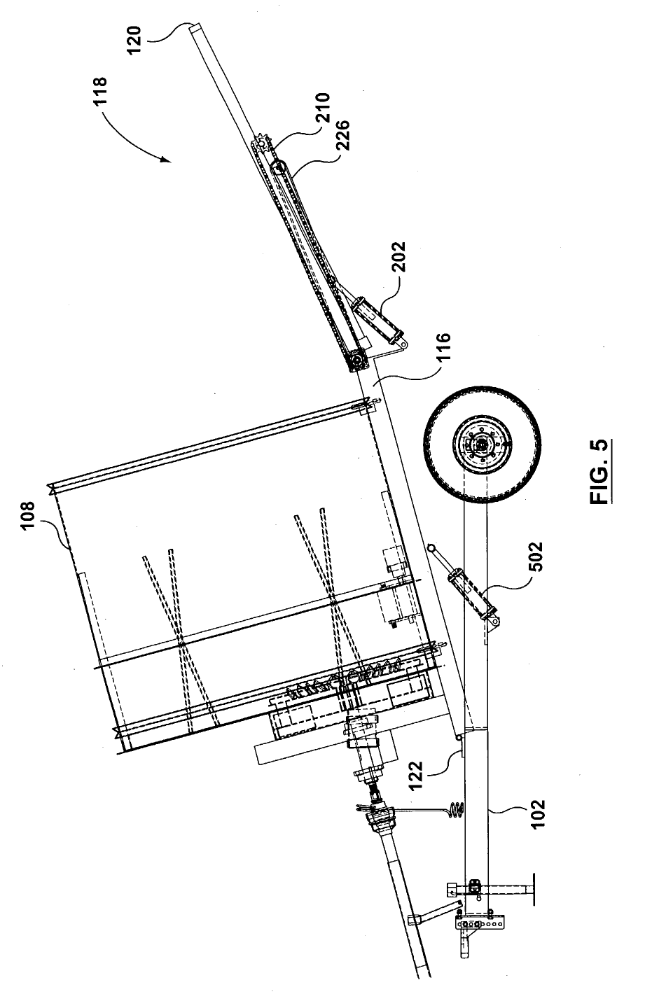

A tub frame 116 is pivotally connected to main frame 102 by a pair of hinges 122. Tub frame actuators 502 (see FIG. 5) may be actuated to pivot tub frame 116 relative to main frame 102. Tub frame actuators 502 may be any suitable mover including manual, electric or, as shown, hydraulic cylinders. Pivoting of tub frame 116 is adapted to change the angle of processing tub 108 from a relatively horizontal position to a position just less than vertical (i.e., under 90 degrees).

Preferably, processing tub 108 is cylindrical and has sufficient dimensions to define an interior cavity 222 (see FIG. 2) that may receive and process large round or large square bales. Processing tub 108 has an open back end and a front end closed by a front wall 124 (se FIG. 1). Front wall 124 is mounted on tub frame 116 and is not connected to, and does not rotate with, processing tub 108. Front wall 124 includes a first opening 125 and a second opening 127 (see FIG. 2). The first opening 125 is provided to facilitate monitoring processing and for maintaining a rear view while backing up to load a bale. The second opening 127 is adapted to receive a rotary cutting fan 208 mounted in a fan housing 110 (see FIG. 1).

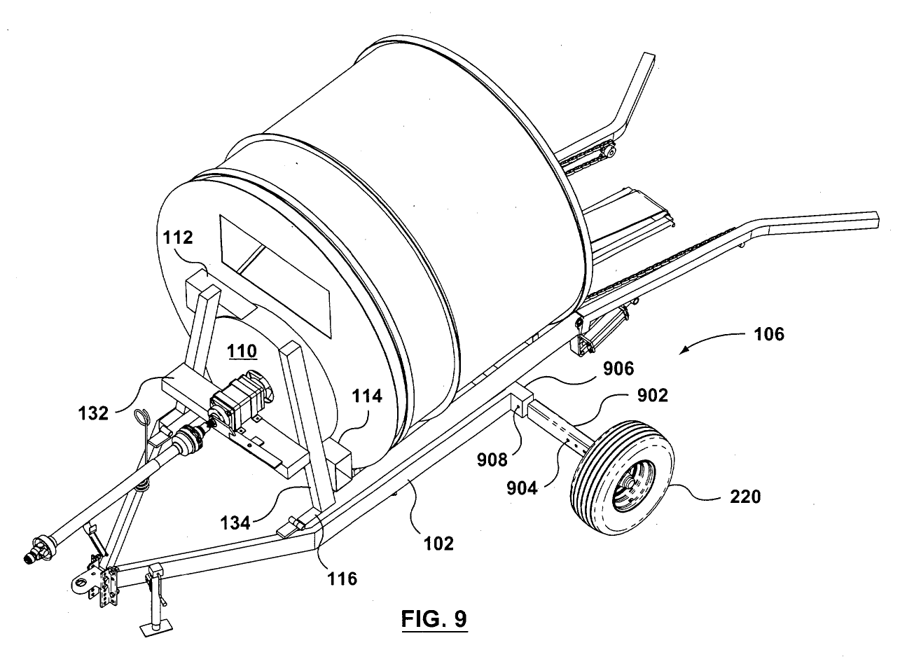

Fan housing 110 has a right side discharge spout 112 and a left side discharge spout 114 (see FIG. 9). A pair of support members 134 mount fan housing 110 to tub frame 116 and support a frame member 132.

In the illustrated embodiment, processing tub 108 is rotated using an endless loop, which may be a belt or chain (not shown), around processing tub 108. Preferably, processing tub 108 is driven to rotate in a direction opposite to the direction of rotation of rotary cutting fan 208. In the view of FIG. 2, rotary cutting fan 208 rotates clockwise and processing tub 108 rotates counter-clockwise.

A set of stabilizing rollers 206 is mounted to tub frame 116 to cooperate with v-groove tracks 402 (FIG. 4) that extend around the circumference of processing tub 108 in order to stabilize rotation of processing tub 108.

A tub rotator 126 (see FIG. 1), that may be any suitable power source including an electric motor, a gas/diesel engine or a hydraulic motor, is mounted on tub frame 116 to drive a drive roller 128 to drive the endless loop to drive the rotation of processing tub 108 about a center axis 404 (see FIG. 4). Also shown in FIG. 1 is a spring loaded tensioner (roller) 129, which is also mounted on tub frame 116. Spring loaded tensioner 129 is biased against said endless loop to maintain a generally constant tension on the endless loop (belt or chain).

Guide vanes 406, shaped to encourage the baled material to move forward (i.e., toward the front of processing tub 108 and toward rotary cutting fan 208) as processing tub 108 is rotated, are mounted on the inside walls of processing tub 108.

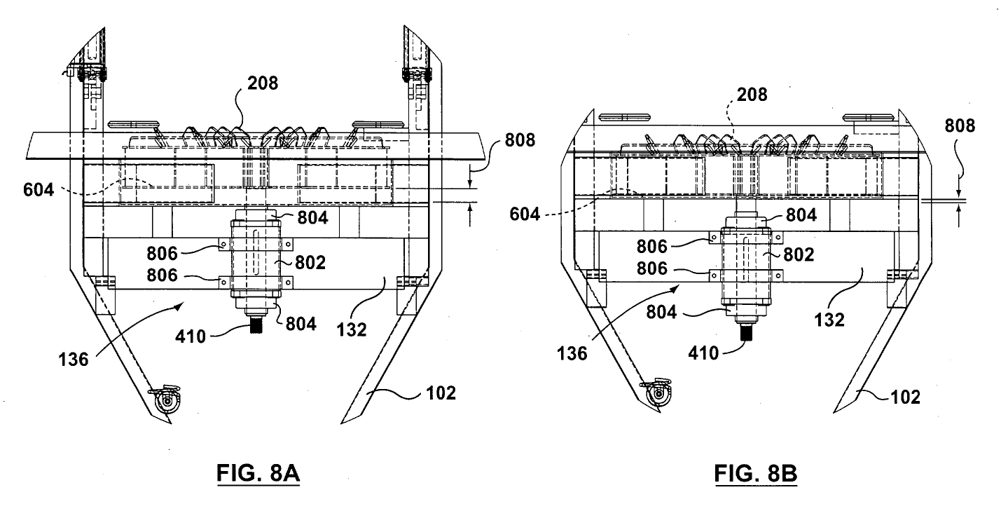

Rotary cutting fan 208 is connected through a fan shaft 410 (see FIGS. 1, 8A and 8B) to a Power Take-Off (PTO) 130 through a pivotal connection, which may include a universal joint or a constant velocity joint. As will be apparent to a person skilled in the art, typical tractors include a PTO stub to which may be connected a PTO that telescopes to allow for a range of distances between the tractor and the device to which power is being supplied. Fan shaft 410 extends through a bearing assembly 136. A universal joint, which is a standard feature of PTO 130, provides the ability to pivot fan shaft 410 relative to the axis of rotation of PTO 130 thereby facilitating operation of the cutting fan at variable angles to the main frame.

Bearing assembly 136 (see FIGS. 1, 8A and 8B) is mounted to fan shaft 410 between the end of fan shaft 410 that connects to PTO 130 and the point where fan shaft 410 enters into fan housing 110. As shown in FIG. 8A, bearing assembly 136 includes bearing mounts 804 secured to either end of a box member 802. The combination of box member 802 and bearing mounts 804 allows fan shaft 410 to rotate while restricting axial movement of fan shaft 410. Box member 802 is secured to frame member 132 by a pair of brackets 806. Axial movement of fan shaft 410, i.e., the adjustment of the extent of protrusion of rotary cutting fan 208 into processing tub 108, is allowed when brackets 806 are loosened. Box member 802 may then be repositioned, thereby easily selecting the extent of protrusion of rotary cutting fan 208 into processing tub 108. Brackets 806 may be tightened to maintain box member 802 in the selected position.

FIGS. 8A and 8B illustrate the fan aggression adjustment system in two positions. In FIG. 8A, the position of rotary cutting fan 208 has been adjusted such that a distance 808 has been established between the front disk 604 and the front wall of the fan housing. In FIG. 8B, the aggression has been adjusted such that rotary cutting fan 208 protrudes into the interior of the processing tub 108 to a lower degree (i.e., distance 808 between front disk 604 and the front wall of the fan housing has been reduced).

It will be understood by those skilled in the art that loosening brackets 806 to reposition box member 802 is only presented as an exemplary method of axially adjusting the extent of protrusion of rotary cutting fan 208 into processing tub 108. It will be further understood that axial adjustment of the extent of protrusion of rotary cutting fan 208 into processing tub 108 may be effected in a number of ways. For instance, the position of frame member 132, to which box member 802 is fastened by brackets 806, may be adjusted. In a further embodiment of the present invention, a linkage system may be used to axially adjust the extent of protrusion of rotary cutting fan 208 into processing tub 108. Such a linkage system may be dependent upon the angle of processing tub 108 relative to main frame 102.

Although the PTO 130 is a convenient power source for rotary cutting fan 208 whose protrusion into processing tub 108 is adjustable, power may be supplied by any one of a number of alternative powers sources, such as an electric motor. If the shaft connecting the electric motor to fan shaft 410 is not telescopic, provision must be made to adjust the position of the electric motor in conjunction with the adjustment of the position of bearing assembly 136, or frame member 132.

Preferably, the axis of rotation of the rotary cutting fan 208 is maintained generally parallel to the axis of rotation of the processing tub 108. Accordingly, as shown in FIG. 4, preferably center axis 408 of rotary cutting fan 208 and center axis 404 of processing tub 108 are substantially parallel. Processing tub 108 and rotary cutting fan 208 are preferably mounted in line with the direction of travel of drum shredder 100.

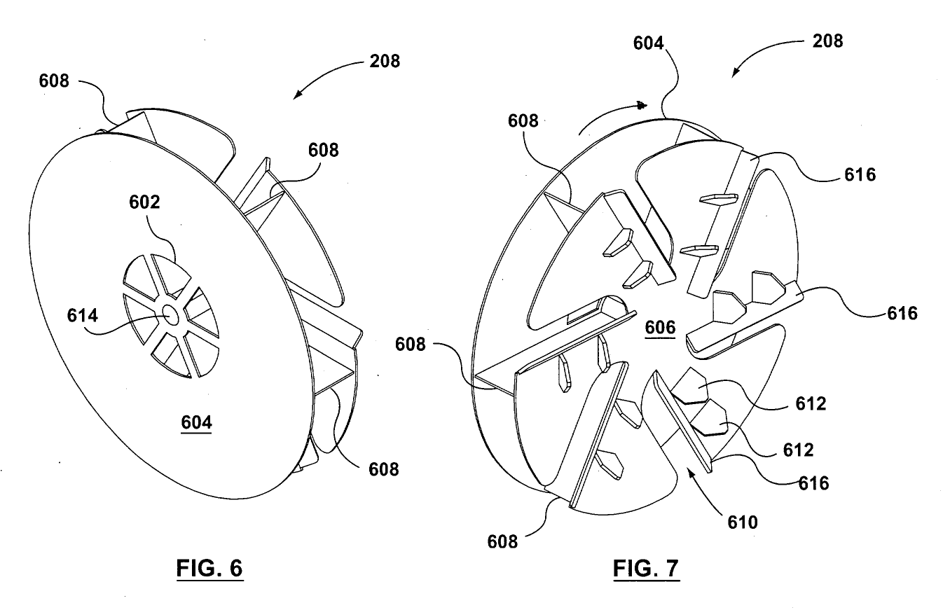

As illustrated in FIGS. 6 and 7, rotary cutting fan 208 includes two disks: a front disk 604; and a back disk 606. Front disk 604 is attached to back disk 606 by fan blades 608. As shown in FIG. 6, apertures 602 are provided in front disk 604. A hole 614 in front disk 604 is adapted to receive and engage with fan shaft 410. Fan shaft 410 is attached to rotary cutting fan 208.

FIG. 7 shows the configuration of back disk 606 including a number of cut-outs 610, where each cut-out 610 is associated with a material diverter 616. The configuration of back disk 606 also includes mounts for a number of cutting knives 612 adapted to engage the baled material in operation and such that the material diverters 616 may direct the cut material through the cut-outs 610 toward the fan blades 608. In the illustrated embodiment, rotary cutting fan 208 is adapted to rotate clockwise, facilitating it being driven from typical tractor PTO's without rotation conversion means. Generally rotation of the rotary cutting fan 208 will be in the range of 1000 RPM or higher.

The diameter of rotary cutting fan 208 is, preferably at least one half the diameter of the processing tub 108 (see FIG. 2). Further, it is preferably located such that the bottom edge of fan housing 110 is generally tangential to the bottom edge of processing tub 108. Given this size and placement of rotary cutting fan 208, situations wherein bales being processed by the drum shredder 100 have portions that are not being shredded may be minimized.

In the preferred embodiment of the drum shredder 100, a loading frame 118 (see FIG. 2) is pivotally attached to the tub frame 116 having forks 120 pivotally mounted directly behind, and in line with, the processing tub 108. Forks 120 are connected to each other proximate processing tub 108 by a connecting bar 230. Loading frame 118 may include a bale support 140 mounted between forks 120.

Loading frame actuators 202, which may, like tub frame actuators 502 (FIG. 5), be any suitable mover including manual, electric or, as shown, hydraulic cylinders, are mounted to support members 205 downwardly extending from the tub frame and to each of the forks 120. The loading frame actuators 202 may be actuated to pivot loading frame 118 relative to the tub frame 116.

Fork-based conveyance members, which, in the illustrated embodiment, are continuous drive chains 210, are associated with each of the forks 120. The drive chains 210 assist loading bales (not shown) onto the forks 120 and into the processing tub 108. Each drive chain 210 cooperates with a drive sprocket wheel 216 on drive axle 212 and freely rotatable sprocket wheel 214 positioned toward a distal end of the corresponding fork 120. The drive axle 212 is driven by conveyor motor 204. As will be apparent to a person skilled in the art, the fork-based conveyance members may alternatively be continuous belts, driven rollers or any other suitable conveyor system and any suitable known drive means may be utilized.

In an alternate embodiment of the present invention, the conveyor motor 204 may be replaced by a transmission unit that contacts the wheel 220 carried by the axle assembly 106 of the main frame 102. Such a transmission unit acts to convert rotation of one of the wheels 220 to rotation of the drive axle 212. Reverse movement of the main frame 102 leads to reverse rotation of the wheel 220 and consequent rotation of the transmission unit and the drive axle 212. Rotation of the drive axle 212 and the drive sprocket wheels 216 acts to move the drive chains 210 to urge the bale toward the open end of the processing tub 108.

Bale support 140 may be necessary to prevent bales from falling between forks 120. In the illustrated embodiment, bale support 140 includes a central conveyance member in the form of an endless conveyor belt 226 that extends from drive axle 212 to a roller 228 and back. Roller 228 is freely rotatable and supported in a position between forks 120 by support bars 224, which extend, generally parallel to forks 120, from connecting bar 230. In addition, to preventing bales from falling between forks 120, the rotation of drive axle 212 moves endless conveyor belt 226 to urge the bale toward the open end of processing tub 108. In an alternative embodiment, the central conveyance member may include multiple chains in place of endless conveyor belt 226.

In alternative embodiments, the support function of bale support 140 may be performed by a third fork, a planar platform or any other suitable support member located between the forks 120.

FIG. 9 illustrates a mechanism for adjusting the width of the axle assembly 106 of the main frame 102. Axle assembly 106 is constructed as a “tube-inside-a-tube”, wherein a first tube 906 is fixed to the main frame 102 and a second tube 902, which carries the axle of one wheel 220, is slidably received by the first tube 906. Second tube 902 is held in place relative to first tube 906 by a pin (not shown) that passes through an appropriately sized aperture 908 in first tube 906 and a similarly-sized aperture 904 in second tube 902.

In the illustrated embodiment, there is need to power rotary cutting fan 208, tub rotator 126, tub frame actuators 502, loading frame actuators 202 and conveyor motor 204. A preferred power arrangement is to drive the rotary cutting fan 208 from the towing tractors PTO. The remaining actuators and motor may be powered through the typical modern tractor's hydraulic system using available remotes and suitable hydraulic connections. For clarity, the hydraulic connections have been omitted from the figures. Further, as will be understood by those skilled in the art, the required power for the various actuators and motors may be effectively provided in a number of suitable known ways.

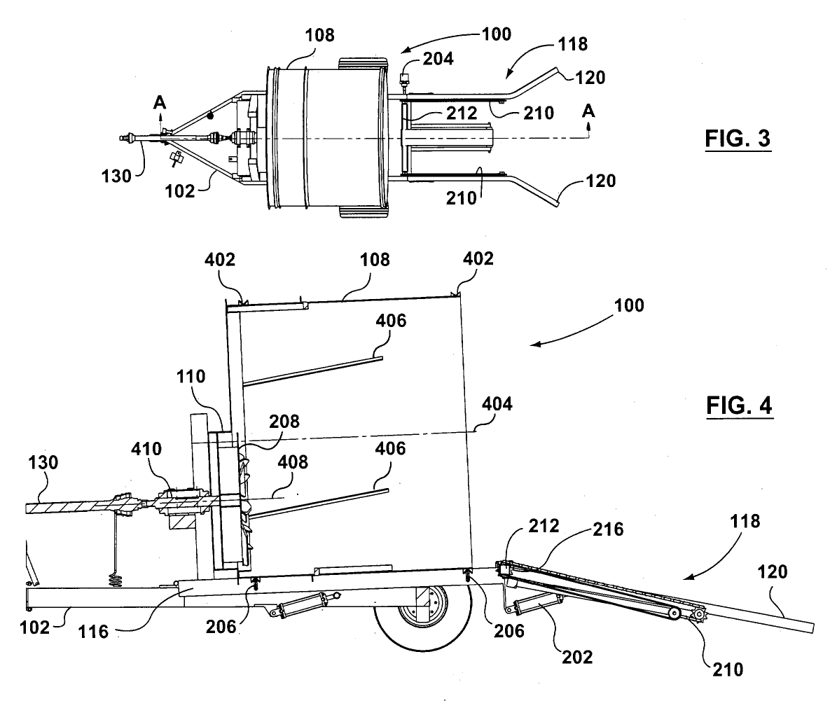

In operation, the angle of loading frame 118 is adjusted to a loading position using loading frame actuator 202. In the loading position, shown in FIG. 4, the ends of the forks 120 are arranged to float on the ground surface thus facilitating sliding underneath a bale to be processed. The fork-based conveyance members are also close to the ground and are able to assist loading the bale onto the forks 120 upon activation of the conveyor motor 204 (see FIG. 3). This causes rotation of drive axle 212 that acts to move the fork-based conveyance members to, in turn, urge the bale toward the open end of the processing tub 108. The central conveyance member associated with bale support 140 may also, responsive to rotation of drive axle 212, urge the bale toward the open end of the processing tub 108.

Once the bale to be processed is entirely, or at least substantially, supported by loading frame 118, tub frame 116 and loading frame 118 are pivoted from the loading position to a tub acceptance position (see FIG. 5). Such pivoting acts to facilitate the bale moving into the open end of the processing tub 108. Additional encouragement is provided by action of drive chains 210, endless conveyor belt 226 and drive axle 212, where drive axle 212 has a square cross-section between forks 120 of the loading frame 118, as shown in FIG. 4.

When a first bale has been loaded into the processing tub 108 a second bale may be loaded onto the loading frame 118 whether or not processing of the first bale has commenced or been completed. If two bales are loaded on the bale processor, when operating, as the length of the first bale is reduced through processing, the second bale may commence entering the interior cavity 222 (see FIG. 2) of the processing tub 108.

To process a bale, PTO 130 is driven by a power source to rotate rotary cutting fan 208. As discussed above, rotary cutting fan 208 is adapted to rotate clockwise at approximately 1000 revolutions per minute. As noted, the power source may be any suitable source but in the preferred arrangement is through the tractor PTO. With PTO 130 rotating the rotary cutting fan 208, the cutting knives 612 (see FIG. 6) cut into the baled material and material diverters 616 direct the cut material through the cut-outs 610 toward the fan blades 608. Rotary cutting fan 208 is contained within the fan housing 110, which, as discussed hereinbefore, includes two discharge spouts 112 (see FIG. 1) to facilitate discharging processed material from the drum shredder 100. The fan blades 608 act to propel the cut material via centrifugal force towards the discharge spouts 112,114. Apertures 602 in front disk 604 allow air to enter rotary cutting fan 208 to assist in the propulsion of the cut material towards the discharge spouts 112, 114. Each discharge spout 112, 114 may be individually opened and closed to choose either right hand discharge or left hand discharge or both.

Depending upon the application, the bale processor is adjusted to control feed rate and material cut length. Generally, the higher the angle of the processor tub relative to the horizontal and the higher the speed and protrusion distance of the rotary cutting fan, the higher the feed rate. The higher the protrusion distance of the rotary cutting fan, the longer the cut length.

For transport, the loading frame 118 is placed in a somewhat vertical transport position and acts as a retainer to keep unprocessed baled materials inside the processing tub 108. The width of the axle may also be narrowed for transport.

As will be apparent to a person skilled in the art, many alternative embodiments exists for the loading frame 118. For instance, in one alternative embodiment, the loading frame 118 may be provided with more than two forks 120 and could, in fact, be realized as a single, flat loading platform.

Other modifications within the ambit of the following claims will be apparent to those skilled in the art and, the invention is accordingly defined by the claims.

We claim:

1. A drum shredder comprising:
a processing tub having a longitudinal axis, a closed end and an open end, said open end being adapted to receive a bale to be shredded in said processing tub; and
a cutter operable to cut material from said bale for discharge from said drum shredder mounted toward said closed end of said processing tub such that the extent of protrusion of said cutter into said processing tub may be adjusted, along an axis generally parallel to said longitudinal axis of said processing tub, to vary the length of the material cut.

2. The drum shredder of claim 1 wherein the cutter includes at least one cutting knife protruding into said processing tub and mounted for rotation on a rotatable drive shaft.

3. The drum shredder of claim 2 wherein said cutter is a rotary cutting fan that includes:
a first disk;
a second disk having at least one cutting knife thereon, a plurality of cut-outs therethrough and a plurality of material diverters thereon;
a plurality of fan blades extending between said first disk and said second disk; and
wherein, in operation, material cut from said bale by said at least one cutting knife is diverted through said cut-outs toward said plurality of fan blades for discharge from the drum shredder.

4. The drum shredder of claim 3 further including a cutting fan housing having at least one discharge spout adapted to direct discharge of said material cut from said bale.

5. The drum shredder of claim 4 wherein said housing includes a left side discharge spout and a right side discharge spout adapted to discharge said material cut from said bale on the left and right side of the drum shredder, respectively.

6. The drum shredder of claim 5 wherein said discharge spouts may be selectively opened and closed.

7. The drum shredder of claim 1 wherein said processing tub is mounted on a tub frame that is pivotally mounted on a main frame for movement between a substantially horizontal loading position and a shredding position wherein said open end is directed upward.

8. The drum shredder of claim 7 wherein said drum shredder further includes a loading frame pivotally mounted to said tub frame and adapted to pivot between a loading position wherein said bale to be shredded is loaded on said loading frame and a tub acceptance position wherein said loading frame is pivoted toward said open end of said processing tub to facilitate loading of said bale to be shredded into said processing tub.

9. The drum shredder of claim 8 further including a conveyor mounted on said loading frame adapted to convey said bale to be shredded from a distal end of said loading frame toward said open end of said processing tub.

10. The drum shredder of claim 9 wherein said loading frame includes at least two forks.

11. The drum shredder of claim 7 wherein said processing tub is mounted on said tub frame for rotation about its longitudinal axis.

12. The drum shredder of claim 11 further including at least one guide vane mounted on an inside wall of said processing tub configured to bias said bale to be shredded toward said closed end as said processing tub rotates.

13. The drum shredder of claim 11 further comprising:
an endless loop positioned around the processing tub; and
a drive roller, mounted on the tub frame, to drive the endless loop to rotate the processing tub.

14. The drum shredder of claim 13 further comprising a spring-biased roller mounted on the tub frame and biased against the endless loop to maintain a generally constant tension on the endless loop.

15. The drum shredder of claim 7 wherein said main frame includes an adjustable axle assembly, said axle assembly including a first tube fixed to said main frame, and a second tube slidably received by said first tube.

16. A drum shredder comprising a processing tub having a longitudinal axis, a closed end and an open end, said open end being adapted to receive a bale to be shredded in said processing tub wherein said processing tub is mounted on a tub frame and wherein a loading frame is pivotally mounted to said tub frame and adapted to pivot between a loading position wherein said bale to be shredded is loaded on said loading frame and a tub acceptance position wherein said loading frame is pivoted toward said open end of said processing tub to facilitate loading of said bale to be shredded into said processing tub.

17. The drum shredder of claim 16 wherein said loading frame is pivotable to a transport position wherein said loading frame at least partially guards said open end of said processing tub.

18. The drum shredder of claim 16 further including a conveyor mounted on said loading frame adapted to convey said bale to be shredded from a distal end of said loading frame toward said open end of said processing tub.

19. The drum shredder of claim 18 wherein said loading frame includes at least two forks.
